(19) United States
(12) Patent Application Publication
(10) Pub. No.: US 2024/0204847 A1
(43) Pub. Date: Jun. 20, 2024

(54) METHOD AND APPARATUS FOR TRANSMITTING CHANNEL STATE INFORMATION

(71) Applicant: ELECTRONICS AND TELECOMMUNICATIONS RESEARCH INSTITUTE, Daejeon (KR)

(72) Inventors: Yong Jin KWON, Daejeon (KR); Han Jun PARK, Daejeon (KR); An Seok LEE, Daejeon (KR); Heesoo LEE, Daejeon (KR); Yun Joo KIM, Daejeon (KR); Hyun Seo PARK, Daejeon (KR); Jung Bo SON, Daejeon (KR); Yu Ro LEE, Daejeon (KR)

(73) Assignee: ELECTRONICS AND TELECOMMUNICATIONS RESEARCH INSTITUTE, Daejeon (KR)

(21) Appl. No.: 18/541,786

(22) Filed: Mar. 8, 2024

(30) Foreign Application Priority Data
Dec. 16, 2022 (KR) 10-2022-0177495

(51) Int. Cl. H04B 7/06; H04W 24/10

(52) U.S. Cl. CPC H04B 7/0626; H04B 7/0632; H04W 24/10

(57) ABSTRACT

Disclosed are CSI transmission method and apparatus. A method of a terminal may comprise: receiving, from a base station, information on a measurement period for at least one channel state information-reference signal (CSI-RS) and a reporting period for transmitting at least one CSI; receiving the at least one CSI-RS during the measurement period; generating at least one measured CSI based on the at least one CSI-RS; generating at least one predicted CSI through a CSI prediction model based on the at least one CSI-RS and the at least one CSI; and transmitting the at least one measured CSI and the at least one predicted CSI to the base station.

### CROSS-REFERENCE TO RELATED APPLICATIONS

This application claims priority to Korean Patent Application No. 10-2022-0177495, filed on Dec. 16, 2022, with the Korean Intellectual Property Office (KIPO), the entire contents of which are hereby incorporated by reference.

### BACKGROUND

### 1. Technical Field

Exemplary embodiments of the present disclosure relate to a technique for transmitting channel state information, and more specifically, to a technique for predicting channel information and transmitting predicted channel state information.

### 2. Related Art

Cellular communication systems may require accurate channel state information (CSI) to increase wireless capacity. For accurate CSI, a base station may transmit a CSI-reference signal (CSI-RS) to a terminal. The terminal may measure the CSI-RS transmitted by the base station. The terminal may transmit a result of measuring the CSI-RS to the base station in a predefined CSI form. The base station may utilize the CSI transmitted by the terminal for downlink transmission.

When generating CSI, the existing terminal uses a CSI-RS transmitted by the base station at a time of generating the CSI. However, the terminal may use artificial intelligence (AI) for accurate CSI. The present disclosure proposes techniques for the terminal to predict CSI based on AI. Such the CSI prediction techniques may include a technique for calculating CSI or transmitting the CSI.

### SUMMARY

Exemplary embodiments of the present disclosure are directed to providing a method and an apparatus for transmitting channel state information.

According to a first exemplary embodiment of the present disclosure, a method of a terminal may comprise: receiving, from a base station, information on a measurement period for at least one channel state information-reference signal (CSI-RS) and a reporting period for transmitting at least one CSI; receiving the at least one CSI-RS during the measurement period; generating at least one measured CSI based on the at least one CSI-RS; generating at least one predicted CSI through a CSI prediction model based on the at least one CSI-RS and the at least one CSI; and transmitting the at least one measured CSI and the at least one predicted CSI to the base station.

The method may further comprise: compressing at least one predicted channel quality indicator (CQI) included in the at least one predicted CSI through a compression model of the terminal.

The at least one predicted CQI may include a CQI bitmap indicating presence or absence of a CQI for a prediction time point in a time region.

The compressing of the at least one predicted CQI may comprise: compressing CQIs predicted for a plurality of time points, the plurality of time points being or being not consecutive.

The compressing of the at least one predicted CQI may comprise: compressing CQIs predicted for a plurality of time points, the plurality of time points being or being not consecutive; and when a predicted CQI for a measurement frequency resource does not exist for a time point, performing compression using a CQI for a frequency resource adjacent to the measurement frequency resource.

The compressing of the at least one predicted CQI may comprise: compressing CQIs predicted for a plurality of time points, the plurality of time points being or being not consecutive; determining a base CQI as a reference; generating a differential CQI using a difference between the base CQI and a CQI; and compressing the CQI by expressing the CQI based on the differential CQI.

The transmitting of the at least one measured CSI and the at least one predicted CSI to the base station may comprise: transmitting a portion of the predicted CQIs; and transmitting a remaining portion of the predicted CQIs, excluding the portion of the predicted CQIs, to the base station at an update time point set by the base station.

According to a second exemplary embodiment of the present disclosure, a method of a base station may comprise: transmitting, to a terminal, information on a measurement period for at least one channel state information-reference signal (CSI-RS) and a reporting period for transmitting at least one CSI to the base station; transmitting the at least one CSI-RS during the measurement period; and receiving at least one measured CSI and at least one predicted CSI from the terminal.

The method may further comprise: decompressing at least one channel quality indicator (CQI) included in the at least one predicted CSI through a decompression model of the base station.

The decompressing of the at least one predicted CQI included in the at least one predicted CSI may comprise: decompressing CQIs predicted for a plurality of time points, the plurality of time points being or not being consecutive.

The decompressing of the at least one predicted CQI may comprise: receiving a portion of the predicted CQIs; and receiving a remaining portion of the predicted CQIs, excluding the portion of the predicted CQIs, from the terminal at an update time point set by the base station.

According to a third exemplary embodiment of the present disclosure, a terminal may comprise at least one processor, wherein the at least one processor may cause the terminal to perform: receiving, from a base station, information on a measurement period for at least one channel state information-reference signal (CSI-RS) and a reporting period for transmitting at least one CSI; receiving the at least one CSI-RS during the measurement period; generating at least one measured CSI based on the at least one CSI-RS; generating at least one predicted CSI through a CSI prediction model based on the at least one CSI-RS and the at least one CSI; and transmitting the at least one measured CSI and the at least one predicted CSI to the base station.

The at least one processor may further cause the terminal to perform: compressing at least one predicted channel quality indicator (CQI) included in the at least one predicted CSI through a compression model of the terminal.

The at least one predicted CQI may include a CQI bitmap indicating presence or absence of a CQI for a prediction time point in a time region.

In the compressing of the at least one predicted CQI, the at least one processor may further cause the terminal to perform: compressing CQIs predicted for a plurality of time points, the plurality of time points being or being not consecutive.

In the compressing of the at least one predicted CQI, the at least one processor may further cause the terminal to perform: compressing CQIs predicted for a plurality of time points, the plurality of time points being or being not consecutive; and when a predicted CQI for a measurement frequency resource does not exist for a time point, performing compression using a) CQI for a frequency resource adjacent to the measurement frequency resource.

In the compressing of the at least one predicted CQI, the at least one processor may further cause the terminal to perform: compressing CQIs predicted for a plurality of time points, the plurality of time points being or being not consecutive; determining a base CQI as a reference; generating a differential CQI using a difference between the base CQI and a CQI; and compressing the CQI by expressing the CQI based on the differential CQI.

In the transmitting of the at least one measured CSI and the at least one predicted CSI to the base station, the at least one processor may further cause the terminal to perform: transmitting a portion of the predicted CQIs; and transmitting a remaining portion of the predicted CQIs, excluding the portion of the predicted CQIs, to the base station at an update time point set by the base station.

According to the present disclosure, the terminal can improve performance of CSI prediction through a CSI prediction method. The terminal can reduce overhead required for transmitting CSI through the CSI prediction method. Additionally, the terminal can improve transmission performance of CSI through the proposed CSI transmission method. The terminal can reduce the overhead required for transmitting CSI through the proposed CSI transmission method.

### BRIEF DESCRIPTION OF DRAWINGS

FIG. 1 is a conceptual diagram illustrating a first exemplary embodiment of a communication system.

FIG. 2 is a block diagram illustrating an exemplary embodiment of an apparatus.

FIG. 3 is a conceptual diagram illustrating a first exemplary embodiment for describing a method of measuring CSI.

FIG. 4 is a conceptual diagram illustrating a second exemplary embodiment for describing a method of measuring CSI.

FIG. 5 is a flowchart illustrating a first exemplary embodiment for describing a CSI prediction procedure.

FIG. 6 is a flowchart illustrating a second exemplary embodiment for describing a CSI prediction procedure.

FIG. 7 is a conceptual diagram illustrating a third exemplary embodiment for describing a method of measuring CSI.

FIG. 8 is a conceptual diagram illustrating a fourth exemplary embodiment for describing a method of measuring CSI.

FIG. 9 is a conceptual diagram illustrating a first exemplary embodiment for describing a method of compressing CSI.

FIG. 10 is a conceptual diagram illustrating a second exemplary embodiment for describing a method of compressing CSI.

FIG. 11 is a conceptual diagram illustrating a third exemplary embodiment for describing a method of compressing CSI.

FIG. 12 is a conceptual diagram illustrating a fourth exemplary embodiment for describing a method of compressing CSI.

FIG. 13 is a conceptual diagram illustrating a fifth exemplary embodiment for describing a method of compressing CSI.

FIG. 14 is a conceptual diagram illustrating a first exemplary embodiment for describing a one-dimensional CQI bitmap.

FIG. 15 is a conceptual diagram illustrating a second exemplary embodiment for describing a one-dimensional CQI bitmap.

FIG. 16 is a conceptual diagram illustrating a first exemplary embodiment for describing a two-dimensional CQI bitmap.

FIG. 17 is a conceptual diagram illustrating a second exemplary embodiment for describing a two-dimensional CQI bitmap.

FIG. 18 is a conceptual diagram illustrating a third exemplary embodiment for describing a two-dimensional CQI bitmap.

FIG. 19 is a conceptual diagram illustrating a fourth exemplary embodiment for describing a two-dimensional CQI bitmap.

FIG. 20 is a conceptual diagram illustrating a fifth exemplary embodiment for describing a two-dimensional CQI bitmap.

FIG. 21 is a conceptual diagram illustrating a method for updating CQI.

FIG. 22 is a flowchart illustrating a third exemplary embodiment for describing a method for predicting CSI.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

A communication system or a memory system to which exemplary embodiments according to the present disclosure are applied will be described. The communication system or memory system to which the exemplary embodiments according to the present disclosure are applied is not limited to the content described below, and the exemplary embodiments according to the present disclosure may be applied to various communication systems. Here, a communication system may be used in the same sense as a communication network.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

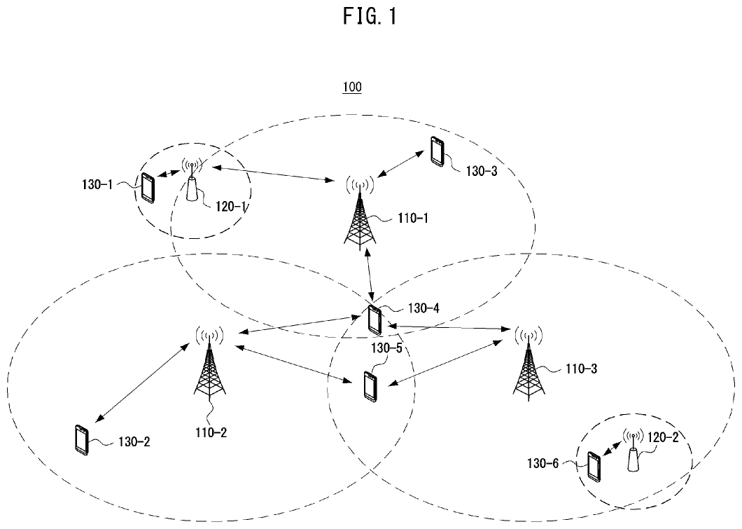

FIG. 1 is a conceptual diagram illustrating a first exemplary embodiment of a communication system.

Referring to FIG. 1, a communication system 100 may include a plurality of communication nodes 110-1, 110-2, 110-3, 120-1, 120-2, 130-1, 130-2, 130-3, 130-4, 130-5, and 130-6. In addition, the communication system 100 may further include a core network (e.g. serving-gateway (S-GW), packet data network (PDN)-gateway (P-GW), and mobility management entity (MME)). When the communication system 100 is the 5G communication system (e.g. NR system), the core network may include an access and mobility management function (AMF), a user plane function (UPF), a session management function (SMF), and the like.

The plurality of communication nodes 110 to 130 may support the communication protocols (e.g. LTE communication protocol, LTE-A communication protocol, NR communication protocol, etc.) defined by technical specifications of 3rd generation partnership project (3GPP). The plurality of communication nodes 110 to 130 may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like. Each of the plurality of communication nodes may mean an apparatus or a device. Exemplary embodiments may be performed by an apparatus or device. A structure of the apparatus (e.g. device) may be as follows.

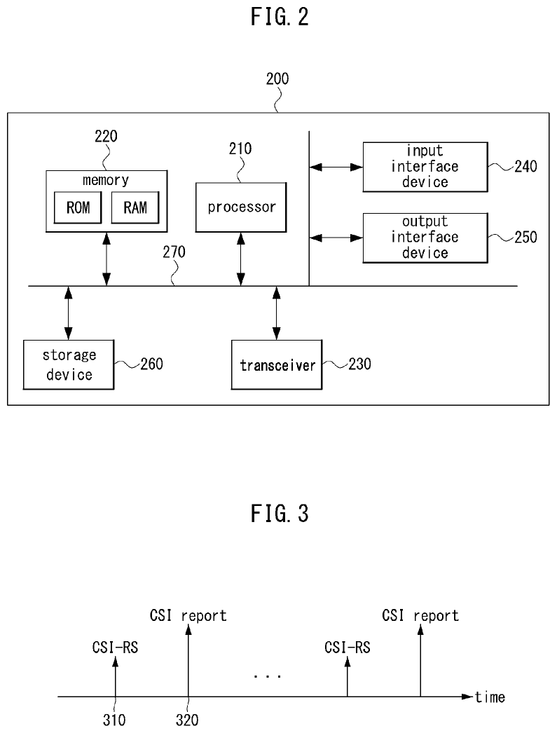

FIG. 2 is a block diagram illustrating an exemplary embodiment of an apparatus.

Referring to FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, an evolved Node-B (eNB), gNB, advanced base station (ABS), a high reliability-base station (HR-BS), a base transceiver station (BTS), a radio base station, a radio transceiver, an access point, an access node, a radio access station (RAS), a mobile multi-hop relay base station (MMR-BS), a relay station (RS), an advanced relay station (ARS), a high reliability-relay station (HR-RS), a home NodeB (HNB), a home eNodeB (HeNB), a roadside unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. a single-user MIMO (SU-MIMO), a multi-user MIMO (MU-MIMO), a massive MIMO, or the like), a coordinated multipoint (COMP) transmission, a carrier aggregation (CA) transmission, a transmission in unlicensed band, device-to-device (D2D) communication (or, proximity services (ProSe)), Internet of Things (IOT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

FIG. 3 is a conceptual diagram illustrating a first exemplary embodiment for describing a method of measuring CSI.

Referring to FIG. 3, illustrated is a process in which the existing terminal measures CSI.

The existing CSI measurement method may be as follows. A base station may transmit a CSI-RS so that the terminal measures CSI. The terminal may receive the CSI-RS transmitted by the base station (310).

The terminal may measure CSI based on the received CSI-RS. The terminal may transmit the measured CSI to the base station at an arbitrary time (320). The arbitrary time may be specified based on the CSI-RS received by the terminal.

The base station may receive the CSI transmitted by the terminal. The base station may utilize the received CSI while performing downlink transmission to the terminal. However, CSI may change over time. Therefore, the terminal and the base station may periodically repeat the existing CSI measurement method. Depending on time, the terminal may repeatedly perform the process of receiving a CSI-RS and transmitting measured CSI to the base station.

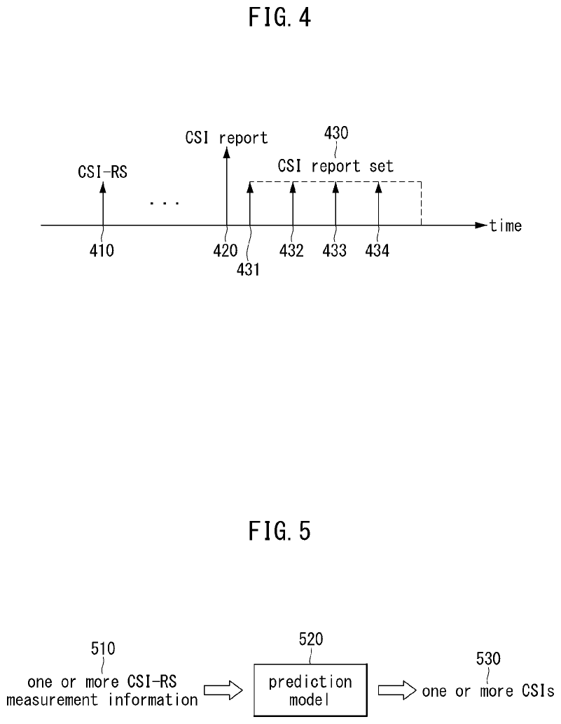

FIG. 4 is a conceptual diagram illustrating a second exemplary embodiment for describing a method of measuring CSI.

Referring to FIG. 4, a terminal may generate CSI through CSI prediction. CSI generated by a CSI prediction model may be referred to as predicted CSI. The CSI prediction may refer to a process of inferring a CSI output by inputting a measurement result of CSI-RS (i.e. measured CSI) into a predefined prediction model. The CSI prediction model may use one or more CSI-RSs and/or one or more measured CSIs as input. The CSI prediction model may infer one or more predicted CSIs as output. The terminal may generate predicted CSI using a predefined CSI prediction model. The predicted CSIs generated by the CSI prediction model may mean CSI(s) predicted for one or more time points. In other words, the predicted CSI generated by the prediction model may mean CSI for a first time point, CSI for a second time point after the first time point, CSI for a third time point after the second time point, CSI for a fourth time point after the third time point, or the like.

The terminal may receive a CSI-RS transmitted by a base station (410). The terminal may measure CSI based on the received CSI-RS. The terminal may transmit the CSI to the base station to report the CSI (420).

The terminal may generate a CSI report set to transmit multiple CSIs. The terminal may transmit predicted CSIs by including them in the CSI report set (i.e. set of CSI reports) (430). The terminal may transmit the predicted CSIs to the base station at a time of CSI reporting. The CSI report set may include one or more CSIs 431, 432, 433, and 434. Each CSI 431, 432, 433, or 434 may mean CSI predicted based on measured CSI. Each CSI 431, 432, 433, or 434 may be CSI for a different time point. In other words, the CSIs 431, 432, 433, and 434 may mean the CSI 431 predicted for a first time point, CSI 432 predicted for a second time point, CSI 433 predicted for a third time point, and CSI 434 predicted for a fourth time point, respectively. The first time point, second time point, third time point, fourth time point, fifth time point, or the like may mean a time point for which the prediction model predicts CSI. In addition, each of the CSIs 431, 432, 433, and 434 may be transmitted to the base station at a different time point (or time).

FIG. 5 is a flowchart illustrating a first exemplary embodiment for describing a CSI prediction procedure.

Referring to FIG. 5, a CSI prediction process is illustrated. A terminal may generate CSI-RS measurement information by receiving a CSI-RS transmitted by a base station. One or more CSI-RS measurement information may be used as input to a CSI prediction model (510). In addition, the CSI-RS measurement information may include a channel value (e.g. channel matrix) and/or an eigenvector calculated from the channel value.

The CSI prediction model may be an AI-based model (520). Alternatively, the CSI prediction model may be a non-AI based model. In case of an AI-based CSI prediction model, a learning dataset of the CSI prediction model may consist of a pair of already measured CSI-RS measurement information and CSI.

The CSI prediction model may output at least one CSI (530). The predicted CSI may refer to an output of the CSI prediction model. The CSI may include a precoding matrix indicator (PMI), a rank indicator (RI), and/or a channel quality indicator (CQI). As an example, the PMI and RI may represent CSI related to MIMO transmission, and the CQI may indicate a modulation scheme, code rate, and transmission efficiency that can be used depending on a channel state of the terminal. Further, the PMI, which is precoding information selected by a received, may be expressed using a codebook previously agreed upon with a transmitter. The RI may mean the maximum number of layers of a MIMO channel. The output of the CSI prediction model may include some or all of the CSI.

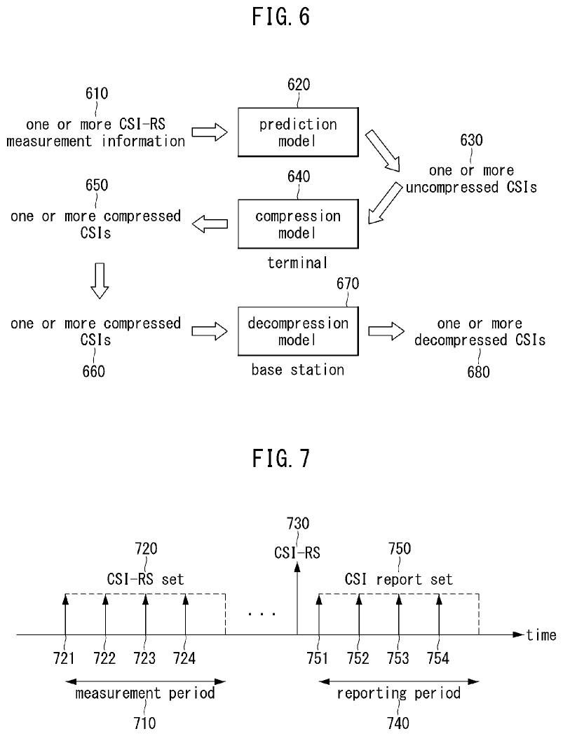

FIG. 6 is a flowchart illustrating a second exemplary embodiment for describing a CSI prediction procedure.

Referring to FIG. 6, the present disclosure may use a CSI prediction model and a CSI compression model. The terminal may include the CSI prediction model and the CSI compression model. The CSI prediction model may be an AI-based model. Alternatively, the CSI prediction model may be a non-AI based model. When the CSI prediction model is a non-AI based model, the CSI prediction model may be a model that uses linear regression and/or Kalman filter. When the CSI prediction model is an AI-based model, the CSI prediction model may be a model that uses a Convolutional Neural Network (CNN), Long Short-Term Memory (LSTM), Transformer Neural Network, Multi-Layer Perceptron (MLP)-mixer, or the like.

The terminal may generate CSI-RS measurement information based on a CSI-RS transmitted by the base station. The CSI prediction model included in the terminal may receive one or more CSI-RS measurement information 610. The CSI prediction model 620 may output at least one or more predicted CSIs based on at least one or more CSI-RS measurement information. At least one output CSI may be referred to as output value(s). At least one predicted CSI output from the CSI prediction model may mean at least one uncompressed predicted CSI 630. In other words, the CSI prediction model may not modify (or compress) the at least one predicted CSI. The terminal may transmit at least one predicted CSI that has not been modified by the CSI prediction model to the base station.

However, the CSI compression model 640 included in the terminal may perform a separate compression process for at least one CSI. The CSI compression model may generate at least one compressed CSI (output value) 650 based on the at least one uncompressed CSI. The terminal may use the compression model to compress the CSI. The CSI compression model included in the terminal may include an encoder in an autoencoder scheme.

The terminal may transmit at least one compressed CSI to the base station (660).

The base station may include a decompression model 670 that restores one or more compressed CSIs 660. The base station may decompress the one or more compressed CSIs and obtain one or more decompressed CSIs 680. The one or more decompressed CSIs 680 may refer to CSIs before being compressed. Transmission of the compressed output values may reduce the overhead increased by the CSI. The base station may use the decompression model to decompress the CSI. The CSI decompression model included in the base station may include a decoder in the autoencoder scheme.

The autoencoder may perform data compression (or dimensionality reduction) by setting the number of neurons in hidden layer(s) between the encoder and decoder to be less than that of an input layer. Such the autoencoder may be constructed based on a CNN. Here, the encoder may be referred to as the compression model. Here, the decoder may be referred to as the decompression model. The encoder of the autoencoder and the decoder of the autoencoder may make bits of the input CSI and bits of the output CSI the same. The autoencoder may compress CQI and PMI separately. Alternatively, the autoencoder may compress CQI and PMI together.

FIG. 7 is a conceptual diagram illustrating a third exemplary embodiment for describing a method of measuring CSI.

Referring to FIG. 7, illustrated is an inference operation of the CSI prediction model over time.

The CSI prediction model included in the terminal may receive one or more CSI-RSs as input for inference. A reason why the CSI prediction model requires one or more CSI-RSs may be to predict channel state characteristics of the terminal. The channel state characteristics of the terminal may change over time due to a Doppler effect, or the like. The CSI prediction model may receive the CSI-RSs as input to predict CSI. In other words, the terminal may receive at least one CSI-RS.

The base station may configure a measurement period and inform it to the terminal. The measurement period may refer to a period in which one or more CSI-RSs are transmitted from the base station to the terminal. When the base station indicates the terminal to report CSI, information on the measurement period may be transmitted as being included in downlink control information (DCI) or a medium access control (MAC) control element (CE).

In addition, the base station may configure a reporting period and inform it to the terminal. The reporting period 740 may refer to a period in which one or more CSIs are transmitted from the terminal to the base station. When the base station indicates the terminal to report CSI, information on the reporting period may be transmitted as being included in DCI or a MAC CE.

The terminal may receive at least one CSI-RS during the measurement period 710.

One or more CSI-RSs 721, 722, 723, and 724 may constitute a CSI-RS set 720. The terminal may receive the CSI-RS set.

The terminal may measure CSI based on the received CSI-RS set. The terminal may report the measured CSI to the base station a certain time period after the measurement period (730). In addition, the terminal may transmit CSI predicted for a predetermined time period to the base station.

The terminal may transmit the predicted CSI during the reporting period. The terminal may transmit a CSI report set 750 to the base station during the reporting period. The CSI report set may consist of one or more CSIs 751, 752, 753, and 754. In other words, the CSI report set may include the CSI 751 predicted for a first time point, CSI 752 predicted for a second time point, CSI 753 predicted for a third time point, and CSI 754 predicted for a fourth time point. The terminal may transmit CSIs included in the CSI report set all at once. Alternatively, the terminal may transmit the CSIs included in the CSI report set at different times. The terminal may transmit the CSI 751 predicted for the first time point to the base station at the first time point. The terminal may transmit the CSI 752 predicted for the second time point to the base station at the second time point. The terminal may transmit the CSI 753 predicted for the third time point to the base station at the third time point. The terminal may transmit the CSI 754 predicted for the fourth time point to the base station at the fourth time point. The predicted CSI may include information on a reporting timing. For example, the CSI predicted for the first time point transmitted to the base station may include information on the first time point.

The base station may receive the CSI(s) transmitted by the terminal. The CSI(s) transmitted by the terminal may be referred to as reported CSI(s). The reported CSI(s) may include the measured CSI(s). Additionally, the reported CSI(s) may include CSI(s) predicted by the CSI prediction model.

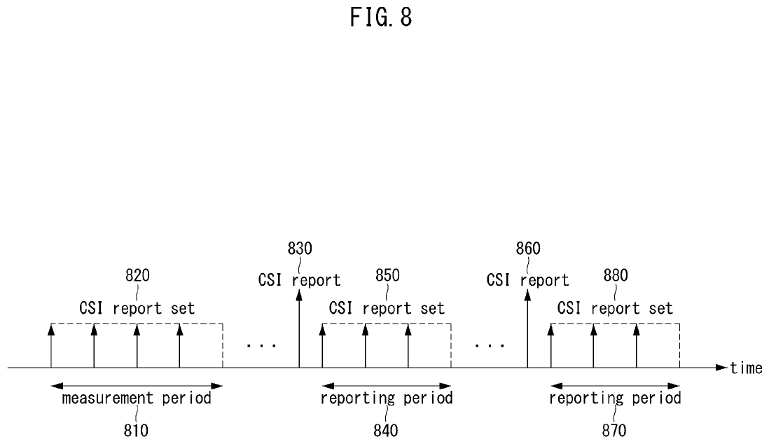

FIG. 8 is a conceptual diagram illustrating a fourth exemplary embodiment for describing a method of measuring CSI.

Referring to FIG. 8, an operation for CSI prediction is described. One measurement period 810 and one reporting period 840 or 870 may not always be consecutive.

The terminal may transmit predicted CSI to the base station in the first reporting period 840 and the second reporting period 880 at a predetermined time after the first measurement period 810. In addition, the terminal may transmit the predicted CSI to the base station in one or more reporting periods at a predetermined time after multiple measurement periods.

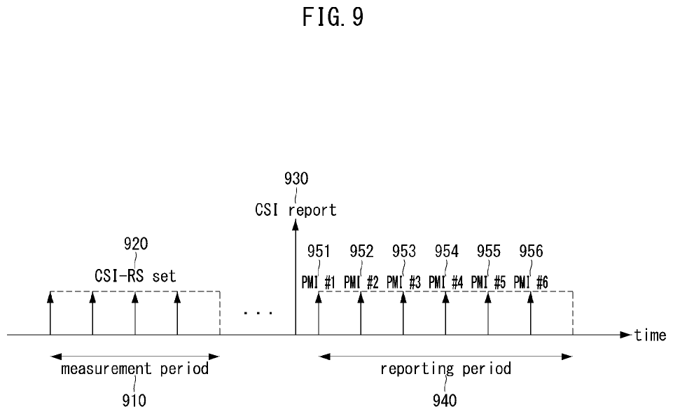

FIG. 9 is a conceptual diagram illustrating a first exemplary embodiment for describing a method of compressing CSI.

Referring to FIG. 9, illustrated is a method of transmitting a PMI included in CSI in a process of CSI prediction. One CSI predicted at a specific time point may include one PMI. Therefore, when the terminal transmits CSIs at multiple time points within the reporting period, the terminal may transmit PMIs as many as the multiple time points. For example, if the number of prediction time points of CSIs transmitted by the terminal is 6, the terminal may transmit 6 PMIs 951, 952, 953, 954, 955, and 956 to the base station. Each of the PMIs 951, 952, 953, 954, 955, and 956 may mean a PMI predicted for a specific time point.

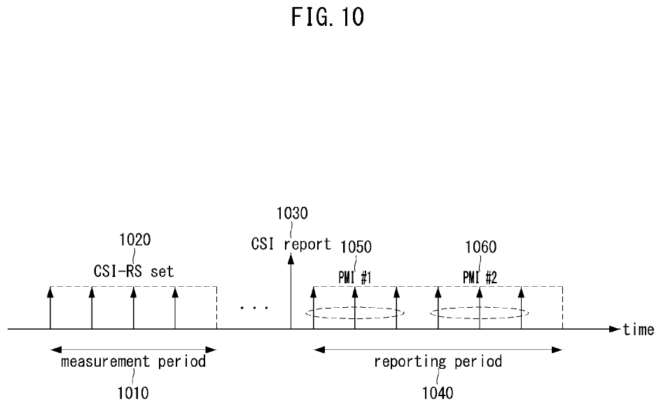

FIG. 10 is a conceptual diagram illustrating a second exemplary embodiment for describing a method of compressing CSI.

Referring to FIG. 10, illustrated is a method for a terminal to transmit multiple PMIs at once. If the terminal transmits multiple PMIs at once, the overhead between the terminal and the base station may increase. The terminal may compress multiple PMIs belonging to multiple time regions into one PMI 1050 or 1060. The terminal may transmit the compressed PMI to the base station. The base station may use the one compressed PMI to inversely calculate PMIs corresponding to the respective time slots.

The terminal may use an AI-based method to compress the PMIs in the time domain. When the terminal compresses the PMIs based on AI, the CSI prediction process and CSI compression process may be structured in a hierarchical structure.

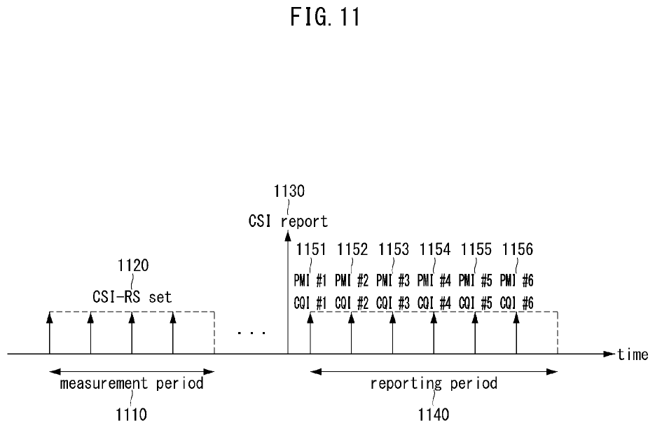

FIG. 11 is a conceptual diagram illustrating a third exemplary embodiment for describing a method of compressing CSI.

Referring to FIG. 11, illustrated is a CQI transmission method in a CSI prediction process. The terminal may include CQI in CSI. The terminal may first set a PMI to calculate a CQI. In a process of transmitting CSI, the terminal may include one PMI and one CQI in the CSI at one time point. The PMI and CQI included in the CSI may be predicted at the same time point. For example, a PMI #1 and a CQI #1 may be predicted at the same time pint 1151. Each CQI (e.g. CQI #1, CQI #2, CQI #3, CQI #4, CQI #5, CQI #6) may mean a predicted value at a different time point.

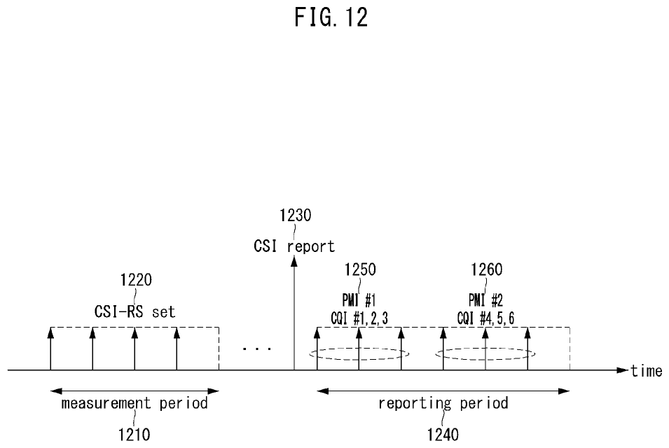

FIG. 12 is a conceptual diagram illustrating a fourth exemplary embodiment for describing a method of compressing CSI.

Referring to FIG. 12, illustrated is a method of transmitting compressed PMI and compressed CQI in a CSI prediction process. The terminal may use a method of compressing PMIs in the time domain. In addition, when the terminal compresses the PMIs in the time domain, the terminal may transmit both one PMI and a CQI corresponding to each time point. For example, the terminal may include one compressed PMI and one or more CQIs in one CSI. In other words, the CSI may include information on a compressed PMI #1 and CQI #1, #2, and #3.

The CQIs #1, #2 and #3 may correspond to different time points. As shown in FIG. 12, the terminal may include three time points in one PMI in CSI. Therefore, the terminal may transmit to the base station one PMI including three CQIs for three time points.

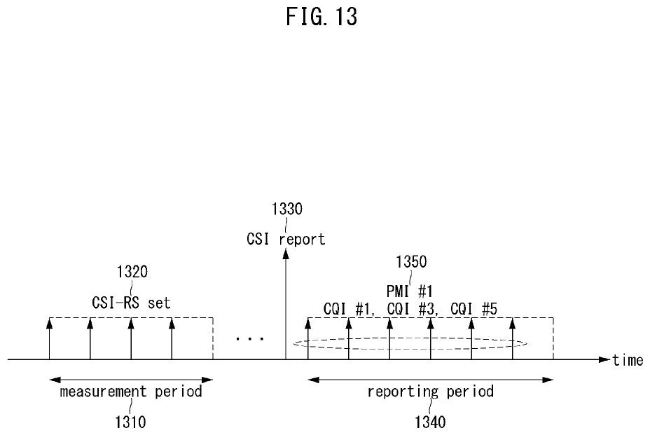

FIG. 13 is a conceptual diagram illustrating a fifth exemplary embodiment for describing a method of compressing CSI.

Referring to FIG. 13, illustrated is a method of transmitting compressed PMI and compressed CQI in a CSI prediction process. When the terminal includes CQIs for all time points in one CSI and transmits the CSI to the base station, the overhead between the terminal and the base station may increase. Therefore, according to the present disclosure, the terminal may omit CQI(s) for some time points in the CSI, and transmit it to the base station.

For example, the terminal may compress 5 CQIs in the time domain and include them in one PMI, and the terminal may transmit one PMI as CSI to the base station. However, the terminal may transmit only three CQIs rather than all of them. In order to transmit only three CQIs, the terminal may need information that can indicate at what time point each CQI was measured and/or for what time point each CQI was predicted. The information that can indicate at what time point each CQI was measured and/or for what time point each CQI was predicted may constitute a CQI bitmap. For example, assuming that there are CQIs for five time points, a time point for CQI #2 may be identified using time points for CQI #1 and CQI #3. Therefore, the terminal may include three CQIs (i.e. CQI #1, CQI #3, and CQI #5) 1350 in a PMI #1 and transmit it to the base station.

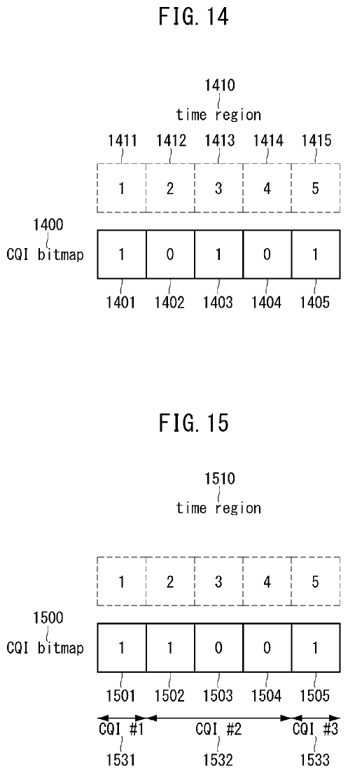

FIG. 14 is a conceptual diagram illustrating a first exemplary embodiment for describing a one-dimensional CQI bitmap.

Referring to FIG. 14, illustrated is a bitmap that can indicate at what time point CQI can be used.

When the terminal and the base station compress multiple PMIs according to prediction time points, one bit of a CQI bitmap 1400 may indicate each prediction time point. For example, the leftmost bit of the CQI bitmap 1400 may indicate a time point 1 1411. The prediction time points may be expressed as prediction time points 1 to 5 (i.e. 1411, 1412, 1413, 1414, and 1415). The prediction time point 1 may mean the earliest prediction time point. Each prediction time point may have a corresponding bit value 1401, 1402, 1403, 1404, or 1405. When multiple CQIs are included in the CSI, a CQI corresponding to the earliest time point may be included in the CSI first. For example, among five CQIs, the CQI for the earliest time point may be included on the leftmost side of the CQI bitmap.

For example, if a bit value for a prediction time point (bit position therefor) in the CQI bitmap is set to 1, this may mean that the corresponding CQI is included in the CSI (1401). If a CQI does not exist, the CQI bitmap may indicate a bit value for the corresponding time point set to 0 (1402).

FIG. 15 is a conceptual diagram illustrating a second exemplary embodiment for describing a one-dimensional CQI bitmap.

Referring to FIG. 15, illustrated is a method of using the closest CQI when a CQI does not exist in the CQI bitmap.

When the terminal transmits CSI to the base station, transmission performance may decrease if CQI at a specific time point does not exist in the CSI. In this case, the terminal may use a CQI at the nearest time point to improve transmission performance. For example, as shown in FIG. 15, when bits 1503 and 1504 for the third and fourth prediction time points of the CQI bitmap are 0, the terminal may use a CQI 1532 for the second time point. However, if there is no CQI at a specific time point, the terminal may not use the previous CQI. In other words, the terminal may determine whether to continue using the previous CQI for a time point at which there is no CQI according to a configuration between the terminal and the base station.

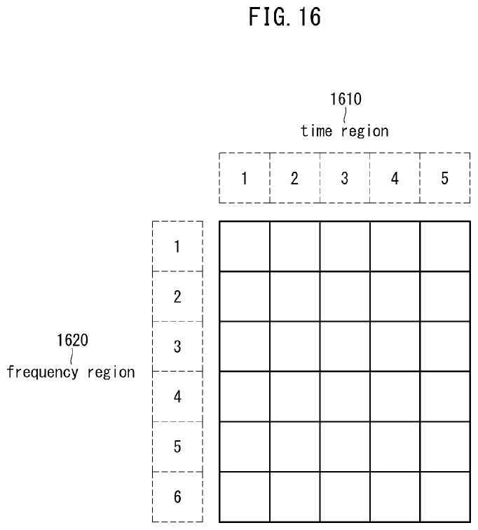

FIG. 16 is a conceptual diagram illustrating a first exemplary embodiment for describing a two-dimensional CQI bitmap.

Referring to FIG. 16, illustrated is a PMI configured for multiple subbands. In FIG. 16, a subband of a two-dimensional CQI bitmap may mean a frequency region 1620. One PMI may include a CQI for each frequency region and time region. In other words, one PMI may include the two-dimensional CQI bitmap.

The two-dimensional CQI bitmap may operate for each subband identically to the one-dimensional bitmap. In the two-dimensional CQI bitmap, a bit set to 1 may mean that the corresponding prediction time point and a CQI for a frequency resource for the corresponding prediction time point are included in the CSI. In the two-dimensional CQI bitmap, a bit set to 0 may mean that the corresponding prediction time point and a CQI for a frequency resource for the corresponding prediction time point are not included in the CSI.

In addition, as described with reference to FIG. 15, the terminal may use a CQI for a time point before or after a target prediction time point according to a configuration between the terminal and base station. In addition, a CQI for a previous time point may be used in the same manner as the one-dimensional CQI bitmap. In addition, a CQI of a nearby frequency resource for the same time point in the two-dimensional CQI bitmap may be used. The nearby frequency resource may mean a frequency resource above or below the corresponding frequency resource in the same time region. The nearby frequency resource may be predetermined according to a configuration between the terminal and the base station.

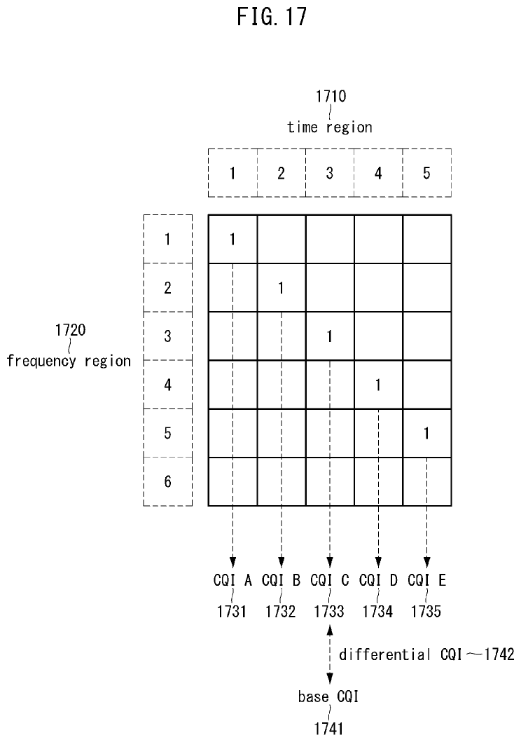

FIG. 17 is a conceptual diagram illustrating a second exemplary embodiment for describing a two-dimensional CQI bitmap.

Referring to FIG. 17, illustrated is a case where the number of bits for a subband and the number of bits for a wideband are different in a two-dimensional CQI bitmap. The subband may mean a frequency region. The wideband may mean a time region.

When expressing a CQI of a subband, the two-dimensional CQI bitmap may indicate a modulation scheme and code rate using a value of bits. The two-dimensional CQI bitmap may represent a differential CQI using a difference between a subband CQI and a wideband CQI (i.e. subband CQI index−wideband CQI index). In other words, the differential CQI may mean a difference between a CQI index of the subband and a CQI index of the wideband. The use of the differential CQI may reduce overhead by reducing the number of bits used as compared to a general CQI. The differential CQI may express a difference from a base CQI which is a reference. The differential CQI may be expressed as Table 1 below.

TABLE 1

| Subband differential | |
|---|---|
| CQI value | Offset level |
| 0 | 0 |
| 1 | 1 |
| 2 | ≥2 |
| 3 | ≤−1 |

The terminal may set a reference CQI to use differential CQIs. The reference CQI may be referred to as a base CQI 1741. The wideband CQI may be the base CQI. Alternatively, a subband CQI may be the base CQI. The base CQI may be set arbitrarily.

The terminal may transmit the two-dimensional CQI to the base station. When the terminal transmits the two-dimensional CQI to the base station, the terminal may express a differential CQI 1742 for each time point by using a difference between each subband CQI 1731, 1732, 1733, 1734, or 1735 and the base CQI. The CSI may include a differential CQI indicating a difference between a CQI whose corresponding bit is set to 1 in the two-dimensional CQI bitmap and the base CQI.

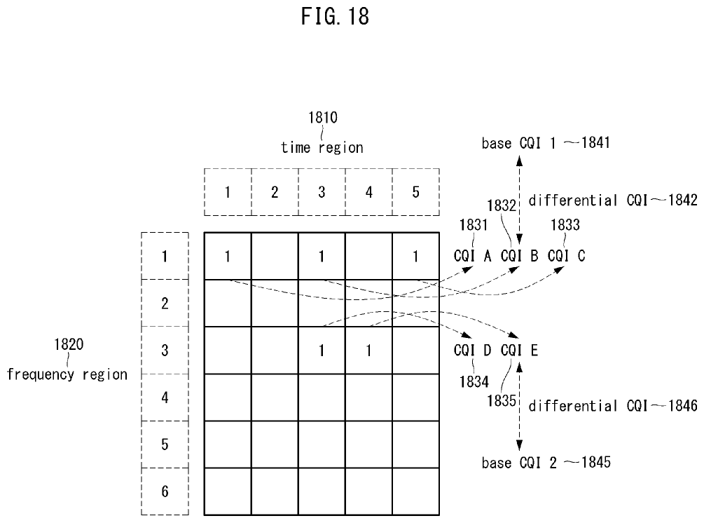

FIG. 18 is a conceptual diagram illustrating a third exemplary embodiment for describing a two-dimensional CQI bitmap.

Referring to FIG. 18, at least one base CQI may exist in one two-dimensional CQI bitmap. In other words, the base CQI may exist separately for each frequency region 1841 or 1845. Alternatively, the base CQI may exist separately for each time region. FIG. 18 illustrates a method in which the terminal generates differential CQIs 1842 and 1846 based on the base CQIs 1841 and 1845 and transmits them to the base station.

For example, the terminal may generate the differential CQI 1842 based on a CQI A 1831, CQI B 1832, and CQI C 1833 belonging to a frequency region 1 and the base CQI 1 1841. The terminal may generate the differential CQI 1846 based on a CQI D 1834 and a CQI E 1835 belonging to a frequency region 3 and the base CQI 2 1845.

Additionally, the terminal may transmit a CQI for the earliest prediction time point in the time domain to the base station as a general CQI. The terminal may express a CQI for a prediction time point after the earliest prediction time point as a differential CQI.

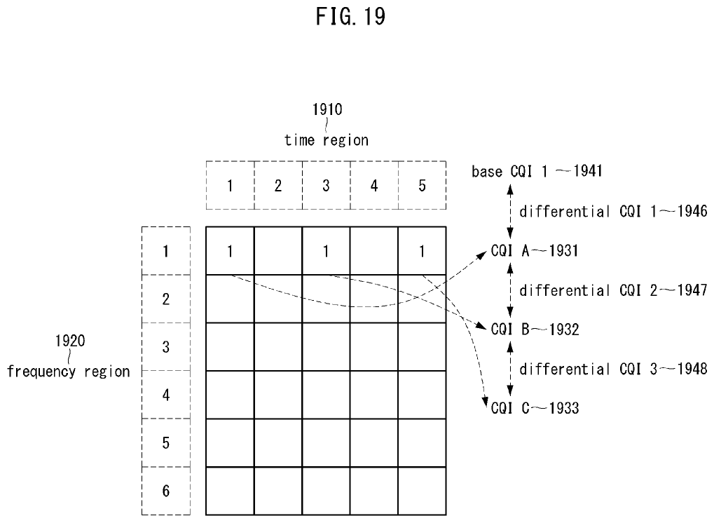

FIG. 19 is a conceptual diagram illustrating a fourth exemplary embodiment for describing a two-dimensional CQI bitmap.

Referring to FIG. 19, the terminal may cumulatively apply differential CQIs and a base CQI 1935. For example, as shown in FIG. 19, a CQI B 1932 may be calculated by accumulating a value of a differential CQI 1946 and a value of a differential CQI 1947. The differential CQI 1946 may represent a difference between a base CQI 1941 and a CQI A 1931. The differential CQI 1947 may represent a difference between the CQI A 1931 and the CQI B 1932. In addition, a CQI C 1933 may be calculated as an accumulation of the differential CQIs 1946, 1947, and 1948 based on the base CQI 1941. Such the accumulation may be applied not only to the time axis but also to the frequency axis.

The terminal may transmit a differential CQI corresponding to a frequency region 1920 and a differential CQI corresponding to a time region 1910 to the base station. The differential CQI corresponding to the frequency region may be expressed as Δ(f). The differential CQI corresponding to the time region may be expressed as Δ(t). In addition, a differential CQI for a specific time and frequency region may be expressed in a cumulative form (Δ(f)+Δ(t)) of the differential CQI corresponding to the frequency region and the differential CQI corresponding to the time region.

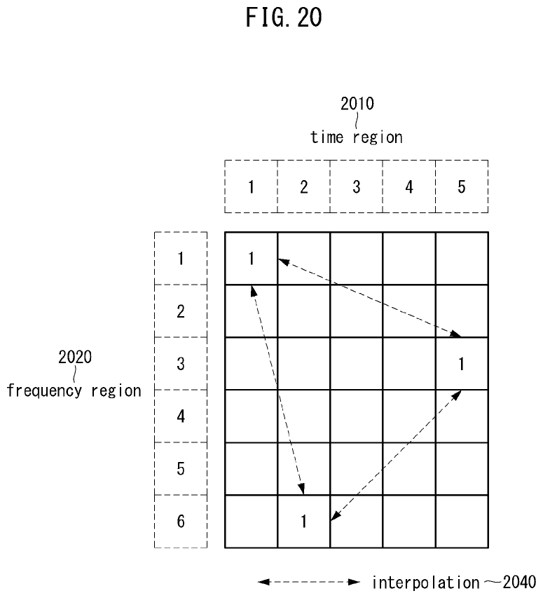

FIG. 20 is a conceptual diagram illustrating a fifth exemplary embodiment for describing a two-dimensional CQI bitmap.

Referring to FIG. 20, illustrated is a method of expressing CQI. The terminal may calculate a CQI for which a resource does not exist in the two-dimensional CQI bitmap based on interpolation using CQIs whose corresponding bits are set to 1 and for which resources exist in the two-dimensional CQI bitmap.

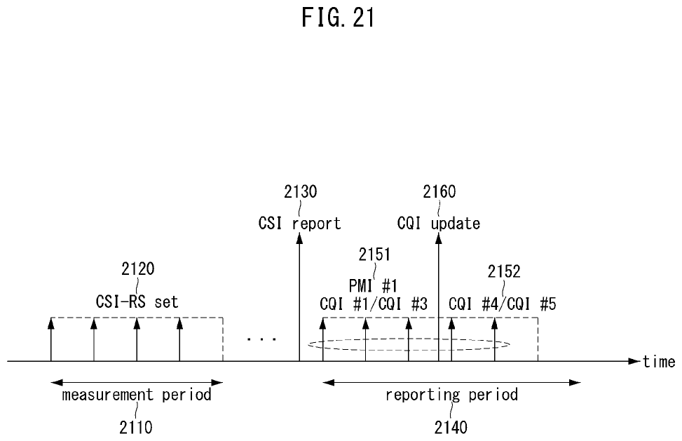

FIG. 21 is a conceptual diagram illustrating a method for updating CQI.

Referring to FIG. 21, illustrated is a method in which the terminal updates CQI after transmitting a PMI including the CQI to the base station. A CQI update procedure may mean a procedure of transmitting multiple CQIs for multiple time points to the base station. In other words, the terminal may transmit a CQI for a time point after a CQI update time point to the base station at the CQI update time point. Accordingly, the present disclosure can reduce the overhead between the terminal and the base station by considering the size of CQI bitmap and the number of CQI bits.

The CQI update procedure may be as follows. The terminal may transmit a least portion 2151 of CQIs predicted for a CSI reporting period 2140 to the base station. For example, the terminal may generate a CQI predicted for a first time point, CQI predicted for a third time point, CQI predicted for a fourth time point, and CQI predicted for a fifth time point. Here, the terminal may transmit only the CQI predicted for the first time point and the CQI predicted for the third time point to the base station. After a predetermined time point, the terminal may update the CQI (2160). In other words, the terminal may transmit the remaining CQI(s) to the base station. The remaining CQI(s) may be CQI(s) that have not been previously delivered. For example, the terminal may transmit the CQI predicted for the fourth time point and the CQI predicted for the fifth time point to the base station at the CQI update time point. Here, the CQI update time point may mean a time point after the third time point. The CQI update time point may be set by the base station, and information on the set CQI update time point may be transmitted to the terminal.

In addition, the terminal may retransmit information on the already transmitted CQIs (2151). For example, the terminal may transmit all the CQI predicted for the first time point, CQI predicted for the third time point, CQI predicted for the fourth time point, and CQI predicted for the fifth time point to the base station at a CSI reporting time point. After a predetermined time point, the terminal may update the CQI (2160). In other words, the terminal may transmit the CQI predicted for the fourth time point and the CQI predicted for the fifth time point again to the base station at a CQI update time point. The base station may update and use the CQI predicted for the fourth time point and the CQI predicted for the fifth time point based on the retransmitted CQI predicted for the fourth time point and CQI predicted for the fifth time point.

To update the CQI, the terminal may use the above-described one-dimensional CQI bitmap or two-dimensional CQI bitmap structure. The CQI update method 2160 may be as follows.

The terminal may receive CSI-RS(s) for a certain time period after transmitting the portion 2151 of CQIs. The terminal may generate a CQI for a new time point based on the received CSI-RS(s). The terminal may transmit the CQI to the base station based on the CQI for the new time point.

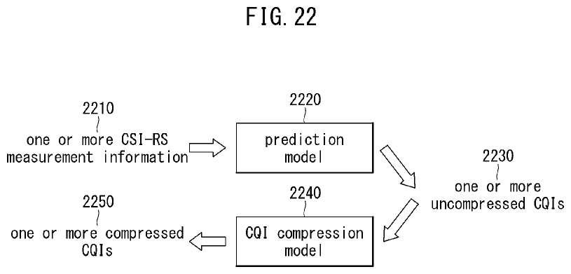

FIG. 22 is a flowchart illustrating a third exemplary embodiment for describing a method for predicting CSI.

Referring to FIG. 22, the terminal may compress CQI(s) using an AI-based method to reduce overhead due to the CQI(s). A CQI compression model may be used simultaneously with a CSI compression model. According to the present disclosure, a CSI prediction model and a CQI compression model may be used. The terminal may include the CSI prediction model and the CQI compression model.

The terminal may generate at least one or more CSI-RS measurement information based on at least one or more CSI-RSs transmitted by the base station. The CSI prediction model included in the terminal may receive at least one or more CSI-RS measurement information (2210). The CSI prediction model 2220 may output one or more predicted CQIs based on the at least one or more CSI-RS measurement information. At least one output CQI may be referred to as an output value. At least one predicted CQI output from the CSI prediction model may mean at least one uncompressed predicted CQI 2230. In other words, the CSI prediction model may not modify the at least one predicted CQI. The terminal may transmit at least one predicted CQI that has not been modified (or compressed) by the CSI prediction model to the base station.

However, the CQI compression model 2240 included in the terminal may perform a separate compression process for at least one CQI. The CQI compression model may generate at least one compressed CQI (output value) 2250 based on the at least one uncompressed CQI 2230. The terminal may use the compression model to compress the CQI. The CQI compression model included in the terminal may include an encode in the autoencoder scheme.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, information on a measurement period for at least one channel state information-reference signal (CSI-RS) and a reporting period for transmitting at least one CSI;
receiving the at least one CSI-RS during the measurement period;
generating at least one measured CSI based on the at least one CSI-RS;
generating at least one predicted CSI through a CSI prediction model based on the at least one CSI-RS and the at least one CSI; and
transmitting the at least one measured CSI and the at least one predicted CSI to the base station.

2. The method according to claim 1, further comprising: compressing at least one predicted channel quality indicator (CQI) included in the at least one predicted CSI through a compression model of the terminal.

3. The method according to claim 2, wherein the at least one predicted CQI includes a CQI bitmap indicating presence or absence of a CQI for a prediction time point in a time region.

4. The method according to claim 2, wherein the compressing of the at least one predicted CQI comprises: compressing CQIs predicted for a plurality of time points, the plurality of time points being or being not consecutive.

5. The method according to claim 3, wherein the compressing of the at least one predicted CQI comprises:
compressing CQIs predicted for a plurality of time points, the plurality of time points being or being not consecutive; and
when a predicted CQI for a measurement frequency resource does not exist for a time point, performing compression using a CQI for a frequency resource adjacent to the measurement frequency resource.

6. The method according to claim 3, wherein the compressing of the at least one predicted CQI comprises:
compressing CQIs predicted for a plurality of time points, the plurality of time points being or being not consecutive;
determining a base CQI as a reference;
generating a differential CQI using a difference between the base CQI and a CQI; and
compressing the CQI by expressing the CQI based on the differential CQI.

7. The method according to claim 4, wherein the transmitting of the at least one measured CSI and the at least one predicted CSI to the base station comprises:
transmitting a portion of the predicted CQIs; and
transmitting a remaining portion of the predicted CQIs, excluding the portion of the predicted CQIs, to the base station at an update time point set by the base station.

8. A method of a base station, comprising:
transmitting, to a terminal, information on a measurement period for at least one channel state information-reference signal (CSI-RS) and a reporting period for transmitting at least one CSI to the base station;
transmitting the at least one CSI-RS during the measurement period; and
receiving at least one measured CSI and at least one predicted CSI from the terminal.

9. The method according to claim 8, further comprising: decompressing at least one channel quality indicator (CQI) included in the at least one predicted CSI through a decompression model of the base station.

10. The method according to claim 9, wherein the decompressing of the at least one predicted CQI included in the at least one predicted CSI comprises: decompressing CQIs predicted for a plurality of time points, the plurality of time points being or not being consecutive.

11. The method according to claim 8, wherein the decompressing of the at least one predicted CQI comprises:
receiving a portion of the predicted CQIs; and
receiving a remaining portion of the predicted CQIs, excluding the portion of the predicted CQIs, from the terminal at an update time point set by the base station.

12. A terminal comprising at least one processor,
wherein the at least one processor causes the terminal to perform:
receiving, from a base station, information on a measurement period for at least one channel state information-reference signal (CSI-RS) and a reporting period for transmitting at least one CSI;
receiving the at least one CSI-RS during the measurement period;
generating at least one measured CSI based on the at least one CSI-RS;
generating at least one predicted CSI through a CSI prediction model based on the at least one CSI-RS and the at least one CSI; and
transmitting the at least one measured CSI and the at least one predicted CSI to the base station.

13. The terminal according to claim 12, wherein the at least one processor further causes the terminal to perform: compressing at least one predicted channel quality indicator (CQI) included in the at least one predicted CSI through a compression model of the terminal.

14. The terminal according to claim 13, wherein the at least one predicted CQI includes a CQI bitmap indicating presence or absence of a CQI for a prediction time point in a time region.

15. The terminal according to claim 13, wherein in the compressing of the at least one predicted CQI, the at least one processor further causes the terminal to perform: compressing CQIs predicted for a plurality of time points, the plurality of time points being or being not consecutive.

16. The terminal according to claim 14, wherein in the compressing of the at least one predicted CQI, the at least one processor further causes the terminal to perform:
compressing CQIs predicted for a plurality of time points, the plurality of time points being or being not consecutive; and
when a predicted CQI for a measurement frequency resource does not exist for a time point, performing compression using a CQI for a frequency resource adjacent to the measurement frequency resource.

17. The terminal according to claim 14, wherein in the compressing of the at least one predicted CQI, the at least one processor further causes the terminal to perform:
compressing CQIs predicted for a plurality of time points, the plurality of time points being or being not consecutive;
determining a base CQI as a reference;
generating a differential CQI using a difference between the base CQI and a CQI; and
compressing the CQI by expressing the CQI based on the differential CQI.

18. The terminal according to claim 15, wherein in the transmitting of the at least one measured CSI and the at least one predicted CSI to the base station, the at least one processor further causes the terminal to perform:
transmitting a portion of the predicted CQIs; and
transmitting a remaining portion of the predicted CQIs, excluding the portion of the predicted CQIs, to the base station at an update time point set by the base station.
